(19) United States
(12) Patent Application Publication
(10) Pub. No.: US 2010/0307973 A1
(43) Pub. Date: Dec. 9, 2010

(54) MOBILE UNIT FOR THE TREATMENT OF RAW WATER

(76) Inventor: Vladimir GRCEVIC, Brignoles (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/304,239

(22) PCT Filed: Jun. 11, 2007
(86) PCT No.: PCT/FR2007/000954

§ 371 Date: Oct. 19, 2009

(30) Foreign Application Priority Data
Jun. 12, 2006 (FR) 0605180

(51) Int. Cl. C02F 1/44; B01D 29/50; B01D 21/01; B65B 3/00; C02F 9/02

(52) U.S. Cl. 210/639; 210/241; 210/202; 141/82; 141/11; 210/652; 210/177

(57) ABSTRACT

The subject of the present invention is a mobile unit for the treatment of raw water. It relates to the technical field of mobile installations and processes for potabilizing raw water for the purpose of providing an immediate solution to supplying drinking water to the heart of regions to be treated as being difficult to access. According to the invention, the mobile unit comprises:—a pumping means (5) for pumping the raw water (4) to be treated, connected to a supply circuit (6);—a transportable container (1) provided with said supply circuit and containing: <span lang=EN-GB style=‘font-size:11.0pt:font-family:Symbol’></span> a system (8) for analyzing the characteristics of the raw water to be treated, <span lang=EN-GB style=‘font-size:11.0pt:font-family:Symbol’></span> a first treatment module (9) for treating soft surface water or drilling water, <span lang=EN-GB style=‘font-size:11.0pt;font-family:Symbol’></span>a second treatment module (10) for treating brackish water or sea water, <span lang=EN-GB style=‘font-size:11.0pt;font-family:Symbol’></span> a third treatment module (11) for treating raw water contaminated by nuclear; radiological, biological and/or chemical (NRBC) agents and <span lang=EN-GB style=‘font-size:11.0pt;font-family:Symbol’></span> a device (15, 16, 120, 121, 122, 123, 124) suitable for directing the flow of raw water to be treated through said treatment modules according to the analyzed characteristics of the raw water. These characteristics allow the mobile unit to be rapidly modified so as to offer suitable treatment according to the characteristics of the raw water and thus obtain water of optimum quality.

An object of the present invention is a mobile unit for the treatment of raw water as well as a method of producing potable water.

It relates to the technical field of mobile facilities and methods enabling the potablisation of raw water in order to provide an immediate solution in the potable water supply in the middle of difficult to access zones to be treated.

Known are mobile units operating independently and capable of being rapidly transported and installed in a disaster area and enabling production of potable water by ultrafiltration from raw water pumped in a borehole, in a river, or in a well.

Known in particular, by the document FR 2,797,439 (GROUPE MAILLOT, is a mobile unit for the production of potable water by ultrafiltration including a transportable container containing suction means capable of drawing raw water to be treated, an ultrafiltration module supplied with raw water and capable of producing potable water, a storage tank for the potable water, and distribution means supplied from the storage tank.

This type of mobile unit is employed mainly to treat raw water that is chemically potable, but not bacteriologically safe. However, some areas may be affected following a nuclear, radioactive, biological and/or chemical (NRBC) accident. In such a case, employed ultrafiltration techniques are not effective for providing water meeting the potability criteria required by WHO (World Health Organization).

Also, depending on the nature of the disaster, it could be that the only available water source is brackish water or sea water. Here again, employed ultrafiltration techniques are ineffective.

In summary, the mobile units known in the prior art are adapted for treating only one type of raw water.

For improving the quality of treated water and avoiding the spread of infectious diseases, the WHO guidelines recommend adapting the treatment of raw waters according to their characteristics.

However, in the techniques known in the prior art, the water analysis are made downstream of the filtration system so that water has generally been distributed and may have been consumed before the results are available.

Furthermore, once results are known, it is necessary to tune the filtration to optimize the potability of the treated water. This is a further loss of time that may have adverse consequences in health emergencies.

Equally important as the treatment and analysis, the packaging of the treated water is a vital link enabling accomplishment of the two previous stages. A packaging of the treated water that does not meet the same required quality criteria as those existing for the phases of analysis and treatment is likely to negate the efforts of potablisation of the water.

But the solutions of the prior art, and particularly that described in FR 2,797,439 (GROUPE MAILLOT), do not enable storage of the treated water in optimal conditions.

Given all the disadvantages of the prior art, the main technical problem contemplated to be solved by the invention is to provide a mobile modular unit according to the characteristics of the raw water to be treated.

An objective of the invention is also to provide a mobile unit capable of producing potable water having quality superior to that obtained by the techniques of the prior art and with a higher hourly flow rate.

Another objective of the invention is to provide a mobile unit capable of providing packaging and supply of potable water meeting the potability criteria required by WHO the time of the installation of a hard infrastructure.

An objective of the invention is also to provide a mobile unit at a low cost, easy to transport and able to be rapidly implemented in the middle of difficult to access disaster zone.

An objective of the invention is also to provide a method enabling production of good quality potable water regardless of the characteristics of the raw water.

The solution provided by the invention is a mobile unit for the treatment of raw water, preferably by a filtration technique, comprising:
a means of pumping raw water to be treated connected to a power supply circuit,
a portable container arranged with said supply circuit and containing:
a system to analyze the characteristics of the raw water to be treated,
a first treatment module for the treatment of fresh surface water or drill water
a second treatment module for the treatment of brackish water or sea water,
a third treatment module of the treatment of raw water contaminated by nuclear, radiological, biological and/or chemical agents,
a device capable of directing the flow of raw water through said treatment modules based on the analyzed characteristics of the raw water.

These characteristics enabling rapid modulation of the mobile unit in order to provide adequate treatment depending on the characteristics of the raw water as well as to obtain an optimal water quality.

According to a preferred implementation feature of the invention, the first treatment module comprises hollow fiber filtration membranes. This filtration technique effectively provides stopping of particle sizes greater than or equal to that of viruses.

According to an advantageous feature of the invention improving the quality of the treated water, a filtration module designed to improve the organoleptic characteristics of the raw water to be treated is arranged downstream of the first treatment module, a means being capable of directing the raw water to be treated into said filtration module according to the analyzed organoleptic characteristics of said raw water.

According to another preferred implementation feature of the invention, the second treatment module is a reverse osmosis unit. The traversed membranes effectively provide the desalination of brackish water or sea water

According to another preferred implementation feature of the invention, the third treatment module is a double stage reverse osmosis unit enabling treatment of the raw water contaminated by NRBC agents.

According to an advantageous feature of the invention enabling optimisation the water treatment, the mobile unit comprises a means to by-passing or short-circuiting one of the two stages of the reverse osmosis unit according to the nature of the analyzed NRBC agents.

According to yet another advantageous feature of the invention, a module for re-mineralization and adjustment of the pH of the treated water is arranged downstream of the double stage reverse osmosis unit to return, if necessary, potable water conforming to vital requirements.

According to yet another advantageous feature of the invention enabling provision of effective treatment of heavily polluted and/or contaminated raw water, the mobile unit comprises a means capable of directing the treated water from the first treatment module to the second or the third treatment module, according to the analyzed characteristics in the raw water.

According to yet another advantageous feature of the invention, a clarification module is arranged upstream of the treatment modules, a means being capable of directing the raw water into said clarification module according to the turbidity analysis.

According to yet another advantageous feature of the invention enabling effectively clarification of the raw water to be treated, the clarification module comprises:
a settling tank for the raw water,
a means to inject a coagulant and/or flocculant into the tank,
a means for pumping the raw clarified water into the tank and injecting it into the first, second or third treatment module.

According to yet another advantageous feature of the invention a bi-layer sand filtration is arranged between the clarification module and the treatment modules, a means being capable of directing the raw water to be treated into said bi-layer filtration module in the case of treatment of water at very high turbidity.

According to yet another preferred feature of the invention enabling provision of packaging and supply of potable water meeting the potability criteria required by WHO, the mobile unit comprises a cooling system for the treated water connected to a module designed to package in the form of bags and/or bottles said treated and cooled water.

According to another advantageous feature of the invention simplified the design and optimizing the cooling of the treated water given its packaging, the cooling system comprises:
a first buffer tank for designed to receive a determined quantity of treated water from the first, second or third treatment module,
a second tank cooperating with a cooling module in order to cool a determined quantity of treated water from said first buffer tank,
a third tank for storage, designed to receive the cooled treated water from said second tank and enabling supply of the packaging module.

According to yet another advantageous feature of the invention, the cooling module and/or packaging module are arranged in other transportable containers to facilitate the delivery and installation of the mobile unit in a difficult to access disaster area.

In yet another advantageous feature of the invention, a module for injecting a chlorine agent is arranged upstream of the packaging module to maintain the residual chlorine effect in the bags and/or bottles.

The invention also relates to a method using the mobile unit in accordance with the previous characteristics to produce in the disaster area potable water meeting the potability criteria required by WHO from raw water. This process comprises:
pumping raw water,
storing the pumped raw water,
analyzing the characteristics of the raw water to be treated,
depending to the characteristics analyzed, directing the flow of raw water:
to a first module for the treatment of fresh surface water or drill water,
to a second module for the treatment of brackish water or sea water,
or to a third module for the treatment of raw water contaminated by nuclear, radiological, biological and/or chemical (NRBC) agents,
treating the raw water by a method determined depending on the analyzed characteristics,
cooling the treated water,

packaging in the form of refrigerated bottles or bags, the cooled treated water.

According to another preferred characteristic of the method, the fresh drilling water or surface water, having a NaCl concentration below 5 g/L, is treated by hollow fiber filtration membranes.

According to yet another preferred feature of the method, at the end of the filtration period, a retro-washing of the filtration membranes is carried out in order to maintain a constant filtration quality over time.

According to yet another preferred feature of the process, brackish water or seawater, having a NaCl concentration greater than or equal to 5 g/L, is treated by a reverse osmosis unit.

According to yet another preferred feature of the process, treating raw water contaminated by nuclear, radiological, biological or chemical (NRBC) agents, is treated by a double stage reverse osmosis unit.

According to yet another preferred feature of the method, brackish water or seawater with a NaCl concentration greater than or equal to about 5 g/L and/or raw water contaminated by NRBC agents, is treated beforehand by hollow fiber filtration membranes.

According to yet another preferred feature of the process, raw water, having turbidity greater than 150 NTU, is clarified beforehand, before the treatment stage.

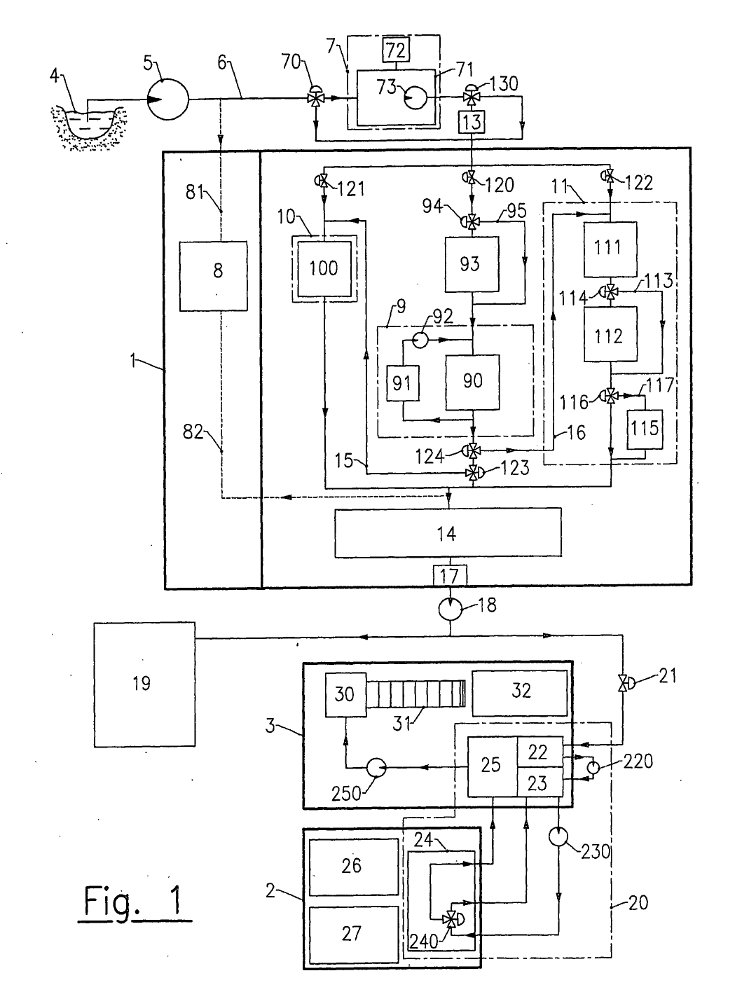

Other advantages and features of the invention will become more apparent upon reading the description of a implementation mode that will follow, with reference to the attached FIG. 1, implemented by way of indicative, non-limiting example only and schematically representing the mobile unit according to the invention.

In referring to FIG. 1, the mobile unit is constituted by a transportable container 1 for the treatment of raw water, a transportable container 2 for the cooling of the treated water and transportable container 3 for the packaging of the potable water.

These containers are transported by road, rail, sea and air. In practice, the container 1 for the treatment of the raw water and the container 3 for the packaging of potable water are 20 foot sea containers. The container 2 for cooling is a 10 foot sea container.

The use of these containers enables rapid transport, by helihoisting of by truck, of the the mobile unit object of the invention over any difficult to access disaster area.

The containers 1, 2 and 3 are interconnected by a pneumatic and electrical supply circuit comprising rapid connections and by food-grade flexible tubing connecting to different interfaces via rapid hydraulic connections.

In an alternative implementation variation not shown, all of the elements are contained in a single transportable container.

The raw water to be treated 4 can come from fresh surface water, drilling, brackish water or sea water (up to 35 g/L NaCl) can be contaminated with nuclear, radioactive, biological and/or chemical agents (NRBC).

The mobile unit comprises a pumping means 5 designed to covery under pressure, via a supply circuit 6, the raw water into the various treatment modules. In practice, it includes a removable centrifugal exhaust pump arranged near the source of raw water to be treated and connected to flexible food-grade piping.

All of this equipment is positioned outside the container 1, but during phases of transport, it can be stored in the free space in the interior of one of the transportable containers 1, 2 or 3.

The container 1 is connected to the supply circuit 6 via one or several hydraulic connections of the Storck® firefighter connection type.

The container 1 is air-conditioned and preferably divided into two parts separated by a partition:
a laboratory room equipped with a system 8 to analyze the characteristics of the raw water to be treated and possibly comprising an office with supervision of a robot via a PC,
an equipment room containing:
a first treatment module 9 for the treatment of fresh surface or drilling water,
a second treatment module 10 for the treatment of brackish water or sea water,
a third treatment module 11 for the treatment of raw water, nuclearlly, radiologically, biologically and/or chemically contaminated.

The following openings and access are provided: two lateral doors on a common side fitted with a window for entry and exit of personnel in the laboratory room and a double swinging door at the end of the container, at the equipment room side.

According to the invention, the analysis and the treatment of the raw water are not successive stages, but are instead intrinsically linked. There is an overlapping and accurate monitoring during both phases. The water is analyzed before and after the filtration stages.

In practice, a sample of raw water is taken upstream of treatment modules 9, 10 and 11 and drawn into the analysis system 8 via a pipe 81. A second analysis is carried downstream of the treatment modules, a sample of treated water being drawn into the analysis system 8 via a pipe 82.

The analysis system 8 comprises equipment designed to analyze the sensory parameters (color, turbidity, odor, taste), the physico-chemical parameters (pH, temperature, conductivity), the microbioiogic parameters, undesirable substances (nitrates, hydrocarbons, . . . ), toxic substances (arsenic, lead, . . . ), pesticides, NRBC agents.

The analysis system 8 is also equipped with an electromagnetic plate flowmeter coupled to an ultrasound probe enabling determination of the amount of NaCl contained in the raw water to be treaded. Other equivalent measuring apparatus may be considered.

To meet the quality constraints set by international standards as well as facilitating the implementation, the analysis system 8 is a portable laboratory in the form of a briefcase composable until its form is fully integrated with the transportable container 1.

Based on the analyzed characteristics of the raw water, a device is provided to guide the movement of said raw water through the treatment modules 9, 10 and 11. In practice and as described below, it includes a hydraulic circuit connecting the various treatment modules and equipped with valves actuated automatically via a robot connected to the analysis system 8. Manual actuation of the valves may also be provided. The arrangement of pipes and the actuation of the valves enables flow of the raw water into one or several successive treatment modules.

The maximum supply flow rate of treatment modules 9, 10 and 11 is approximately 10 m³/h. The production flow rate varies depending on the origin of the water and turbidity of the water. From fresh surface or drilling water, the average production flow rate is approximately 60 m³/d of potable water for turbidity up to approximately 150 NTU. For the same values of turbidity from brackish water or seawater, the average flow rate of water production is approximately 40 m³/d. Beyond approximately 150 NTU, complementary pre-treatments are further installed in order to maintain previous production flow rates.

For water with a turbidity greater than 150 NTU, a clarification pre-treatment is provided in order to reduce the content of organic materials and suspended solids. In referring to FIG. 1, a clarification module 7 is arranged between the pumping means 5 and the treatment modules 9, 10 and 11.

According to the analyzed turbidity, a means 70 is provided, prior to the treatment stage, for directing the raw water into the clarification module 7. In practice, it includes a three-way valve controlled manually or automatically by the robot and arranged on the supply line 6.

According to the preferred implementation mode shown in FIG. 1, the clarification module comprises:
a settling tank 71 of the flexible plastic opencast tank type,
a means 72 for injecting a coagulant and/or flocculant of the ferric chloride type into the reservoir 71,
a means 73 for pumping the clarified raw water into the reservoir 71 and injecting it into one of the treatment modules 9, 10 or 11. Preferably, a submersible pump is used by flotation.

All of this equipment is positioned outside the container 1, but during phases of transport, it can be stored in the free space in the interior of transportable containers 1, 2 or 3.

For very high turbidity waters (greater than approximately 200 NTU), a filtration stage on bi-layer sand is installed between the clarification stage and the treatment stage. To carry this out, a bi-layer sand filtration module 13 is arranged between the clarification module 7 and the treatment modules 9, 10 and 11.

A means 130 is provided at the outlet of the clarification module 7 to direct the raw water to be treated into the bi-layer sand filtration module 13 when the analyzed turbidity exceeds 200 NTU. In practice, it includes a three-way valve controlled manually or automatically by the robot and arranged on the supply line 6.

A pre-filtration with automatic declogging is preferably inserted upstream of the treatment modules 9, 10 and 11 to ensure the removal of particles larger than 300 microns.

Fresh surface or drilled-well water (with a NaCl concentration less than approximately 5 g/L) is directed to the first treatment module 9. In referring to FIG. 1, the valves 121 and 122 are then closed and the valve 120 is open. The treated water is subsequently stored in a tank 14.

This first module advantageously uses a technique of ultrafiltration by hollow fiber membranes 90. These membranes enable removal of the turbidity and suspended solids from the water as well as the reduction of the presence of micro-organisms. The chemical characteristics of the raw water are not changed, any dissolved form freely traversing the membranes. The use of these membranes enables a 6 log reduction of the total germs, coliforms and Cryptosporidium, a viral reduction of from 1 to 3 log, turbidity below 0.1 NTU and a Fouling index less than 3.

The membranes are made from hollow polyvinylidene fluoride (PVDF) fibers. The nominal cutoff threshold of the membrane is 0.1 μm which achieves a complete removal of all particles and microorganisms larger than this cutoff threshold. The pressurized water passes through the wall of each fiber and exits at their free end. The duration of the filtration depends on the quality of raw water: the lower the turbidity, the longer the duration of the filtration. In case of very high turbidities, the duration of filtration can be reduced to 15 minutes.

The filtration accumulates the particles and the microorganisms at the exterior and at the surface of the hollow fibers and it is necessary to regularly remove this deposit. At the end of the filtration period, a retro-washing is thus advantageously carried out in order to maintain a constant filtration quality over time. In practice, a back-washing is carried out every two hours.

Water from a back-wash module 91 is sent under pressure in the opposite direction of the filtration, filtrate side, using a centrifugal pump 92. At the same time air is blown, concentrate side, from oil-free service air. The simultaneous injection of air and water improves the efficiency of the back-washing. A small quantity of reagent such as chlorine can be injected at the same time as the water back-wash. The injection of chlorine enables the oxidation of organic matter that is deposited at the surface of the membrane and provides the disinfection of the filtrate side of the filtration module and piping. The back-wash subsequently continues with the water alone and without addition of reagent. During this phase, the flow rate of the pump 92 is increased.

If a small portion of the deposits is not removed by the mechanical and hydraulic action performed during back-washing, it is possible to perform a more efficient cleaning of the surface membrane by using a solution adapted to remove the organic matter and an acid solution performing the dissolution of deposits of iron and precipitated carbonates salts and manganese.

The wastes of these stages are collected in a specific tank or retreated directly by a chemical process or by heating.

Downstream of the first treatment module 9, a filtration module 93, designed to improve the organoleptic characteristics of raw water (taste, smell, . . . ), is advantageously provided. This module is arranged upstream of the first treatment module 9. In practice, the filtration module 93 is a granular activated carbon filter.

If the organoleptic characteristics of raw water are satisfactory, a three-way valve 94 controlled by the robot and coupled to a pipeline 95 linking the inlet of the filtration module 93 to the inlet of the first treatment module 9 enabling bypassing of said filtration module 93.

Brackish water or seawater (having a NaCl concentration greater than or equal to approximately 5 g/L) is directed to the second treatment module 10. In referring to FIG. 1, the valves 120 and 122 are then closed and the valve 121 is open. The treated water is subsequently stored in the tank 14.

To implement the second treatment module 10, a reverse osmosis membrane 100, is advantageously used, the reverse osmosis membrane comprising a membrane adapted stop particles of the size of molecules, even of dissolved minerals salts. This technique provides an efficient desalination of the raw water to be treated.

According to the analyzed characteristics of the raw water, the latter can be made to flow into the first treatment module 9 before making it flow into the second treatment module 10. To carry this out, a three-way valve 123 is provided, controlled by the robot and coupled to a pipeline 15 connecting the outlet of the first module 9 to the inlet of the second module 10. The supply water of the second module 10 may also be pumped via the tank 14 storing the water filtered by the first module 9.

Water contaminated by NRBC agents is directed to the third treatment module 11. In referring to FIG. 1, the valves 120 and 121 are then closed and the valve 122 is open. The treated water is subsequently stored in the tank 14.

To implement the third treatment module 11, a double stage reverse osmosis unit is preferably used, each stage 111 and 112 advantageously comprising three membranes arranged in series adapted to stop the NRBC agents.

Depending on the type of NRBC agents to be removed, raw water can be made to flow through two stages 111 and 112 or through single one of these stages. For example, in the case of a chemical agent, the filtration through single stage may be sufficient whereas for a nuclear agent, the filtration through the two stages is necessary. To carry this out, a suitable means to by-pass one of the two stages 111 or 112 of the reverse osmosis unit, according to the analyzed NRBC agent, is provided. In practice, a three-way valve 114, controlled by the robot and coupled to a piping 113 connecting the outlet of the first stage 111 to the outlet of the second stage 112, is used. Depending on the activated pathways of the valve 114, the water is directed either to the second stage 112, or to the storage tank 14.

A re-mineralization module 115 with lime and pH adjustment of the osmosisized water is arranged downstream of the double stage Posmoseur inverter in order to re-mineralize and de-acidify. If necessary, the water to return to neutral pH according to the potable water requirements. This module is activated manually or automatically via the robot connected to the analysis system 8. A three-way valve 116 controlled by the robot and coupled to a piping 117 connecting the outlet of the double stage reverse osmosis unit to the inlet of the module 115 enables the direction of the water into said module.

According to the analyzed characteristics of the raw water, the latter can be made to flow into the first treatment module 9 before making it flow into the third treatment module 11. In referring to FIG. 1, a three-way valve 124 is provided, controlled by the robot and coupled to a pipe 16 connecting the outlet of the first module 9 to the inlet entrance of the third module 11. The supply water of the third module 11 can also be pumped via the tank 14 storing the water filtered by the first module 9.

According to the invention, the mobile unit comprises a cooling system 20 for the treated water connected to a module 30 designed to package, in the form of bags and/or bottles, said treated and cooled water.

A module 17 for injecting a chlorine agent is arranged upstream of the packaging module in order to maintain the residual chlorine effect in the bags and/or bottles. A dosage and injection post of the chlorine dioxide is advantageous used, the injection point of which being arranged at the outlet of the storage tank 14

A pumping means 18 enables drawing of the treated water contained in the storage tank 14 to inject a part of it to the cooling system 20 and the other part to a flexible plastic opencast tank 19. The tank 19 may provide the water requirement of a surgical field unit, 13 m³/d to 33 m³/d. The pumping means 18 and the tank 19 are positioned outside the container during potable water production. During the phases of transport, this equipment may be stored in the free space in the interior of one of the container 1, 2 or 3.

The actuation of a valve 21 enbles flow of a determinated quantity of water into the cooling system 20. According to a preferred implementation mode, it comprises:
a first buffer tank designed to receive a determined quantity of treated water from the storage tank 14. The buffer tank 22 has a capacity of 500 L. It is advantageously arranged in the transportable container 3.
a second tank 23 cooperating with a cooling module 24 so as to cool a determined quantity of treated water from the first buffer tank 22. The second tank 23 has a capacity of 500 L. It is advantageously arranged in the transportable container 3. A pump 220 enables flow of the treated water from the first tank 22 to the second tank 23. The cooling module 24 is a heat exchanger adapted to cool 500 L of water in 20 minutes. It is advantageously arranged in the transportable container 2. Via a pump 230, the water thus flows in a closed circuit between the second tank 23 and the cooling module 24 until complete cooling of the water.
a third storage tank 25 designed for receiving cooled treated water from the second tank 23 and enabling supply to the packaging module 30. The third tank 25 has a capacity of 2 m³. It is advantageously arranged in the transportable container 3. When the cooling of the water is completed, the actuation of valve 240 enables flow from the second tank 23 into the third tank 25. The cooled water contained in the third tank 25 is subsequenly sent via a pump 250 to the packaging module 30.
The packaging module 30 is preferably a packaging machine enabling packaging of food products in the form of flexible bags. The packaging machine is capable of producing up to 1200 bags/h.

The bags come in a format of 1.5 L, are resilient and ensure a food security given by the analysis and treatment beforehand. A recyclable product is used, that can be incinerated without pollution in accordance with ecological principles and guidelines in force. A final disinfection by UV lamp is carried out.

A ramp 31 subsequetnly enables conveyance of the bags of potable water into storage refrigerator 32 before their distribution to people.

The packaging module 30 may also be manifested as a bottling machine for storing treated water in plastic bottles. Packaging of the treated water in the form of blocks of ice, to meet specific local requirements, may also be provided.

The packaging module 30 is advantageously arranged in the transportable container 3, but it can be installed in a tent or on a platform.

Besides the cooling module 24, the transportable container 2 comprises an electric generating set 26 adapted to provide energy to the mobile unit object of the invention for a fully independent operation as well as an air compressor 27.

1. A mobile unit for the treatment of raw water, characterized by the fact that it comprises:
a pumping means for the raw water connected to a power supply circuit
a portable container arranged with said supply circuit and containing:
a system to analyze the characteristics of the raw water to be treated,
a first treatment module for the treatment of fresh surface water or drill water,
a second treatment module for the treatment of brackish water or sea water,
a third treatment module for the treatment of raw water contaminated by nuclear, radiological, biological and/or chemical (NRBC) agents,
a device capable of directing the flow of raw water through said treatment modules based on the analyzed characteristics of the raw water.

2. A mobile unit according to claim 1, wherein the first treatment module comprises hollow fiber filtration membranes.

3. A mobile unit according to claim 2, wherein a filtration module designed to improve the organoleptic characteristics of the raw waterto to be treated is arranged downstream of the first treatment module, a means being capable of directing the raw water to be treated into said filtration module.

4. A mobile unit according to claim 1, wherein the second treatment module is a reverse osmosis unit.

5. A mobile unit according to claim 1, wherein the third treatment module is a double stage reverse osmosis unit.

6. A mobile unit according to claim 5, comprising a means capable of bypassing one of the two stages of the double stage reverse osmosis unit.

7. A mobile unit according to claim 5, wherein a module for re-mineralization and adjustment of the pH of the treated water is arranged downstream of the double stage reverse osmosis unit.

8. A mobile unit according to claim 1, comprising a means capable of directing the treated water from the first treatment module to the second or third treatment module.

9. A mobile unit according to claim 1, wherein a clarification unit is arranged upstream of the treatment modules, a means being capable of directing the raw water to be treated beforehand into said clarification module.

10. A mobile unit according to claim 9, wherein the clarification module comprises:
a settling tank for the raw water,
a means for injecting a coagulant and/or flocculant into the tank,
a means for pumping the raw clarified water into the tank and injecting it into the first, second or third treatment module.

11. A mobile unit according to claim 9, wherein a bi-layer sand filtration is arranged between the clarification module and the treatment modules, a means being capable of directing the raw water to be treated into said filtration module.

12. A mobile unit according to claim 1, comprising a cooling system for the treated water connected to a module designed to package in the form of bags and/or bottles said treated and cooled water.

13. A mobile unit according to claim 12, wherein the cooling system comprises:
a first buffer tank designed to receive a determined quantity of treated water after the first, second or third treatment module,
a second tank cooperating with a cooling module in order to cool a determined quantity of treated water from said first buffer tank,
a third tank for storage, designed to receive the treated cooled water from said second tank and enabling supply of the packaging module.

14. A mobile unit according to claim 13, wherein the cooling module and/or packaging module are arranged in other transportable containers.

15. A mobile unit according to claim 12, wherein a module for injecting a chlorine agent is arranged upstream of the packaging module.

16. A method using the mobile unit in accordance with claim 12, for producing in a disaster area of potable water from raw water, said method conprising:
pumping raw water,
storing the pumped raw water,
analyzing the characteristics of the raw water to be treated,
depending on the analyzed characteristics, directing the flow of raw water:
to a first module for the treatment of fresh surface water or drilling water,
or to a second module for the treatment of brackish water or sea water,
or to a third module for the treatment of raw water contaminated by nuclear, radiological, biological and/or chemical (NRBC)
treating the raw water in a manner determined by the analyzed characteristics,
cooling the treated water
packaging in the from of refrigerated bottles or bags the cooled treated water.

17. A method according to claim 16, wherein fresh drilling water or surface, having a NaCl concentration below 5 g/L, is treated by hollow fiber filtration membranes.

18. A method according to claim 16, wherein brackish water or seawater, having a NaCl concentration greater than or equal to 5 g/L, is treated by through a reverse osmosis unit.

19. A method according to claim 16, wherein reverse osmosis unit raw water contaminated by NRBC agents, is treated by double stage reverse osmosis unit.

20. A method according to claim 16, wherin brackish water or seawater, having a NaCl concentration greater than or equal to 5 g/L and/or raw water contaminated by NRBC agents is treated beforehand, by hollow fiber filtration membranes.

21. A method according to of claim 20, wherein, at the end of the filtration period, a retro-washing of the hollow fiber filtration membranes is performed.

22. A method according to claim 16, wherein raw water, having with turbidity greater than 150 NTU, in clarified beforehand, before the treatment stage.
